(19) United States
(12) Patent Application Publication
(10) Pub. No.: US 2025/0001469 A1
(43) Pub. Date: Jan. 2, 2025

(54) CLEAN-IN-PLACE (CIP) SYSTEM AND PROCESS

(71) Applicant: HABI Tech. I/S, Haslev (DK)

(72) Inventors: Hans Andersen, Gelang Patah, Johur Bahru (MY); Birger Elholm Madsen, Haslev (DK)

(21) Appl. No.: 18/294,929

(22) PCT Filed: Aug. 10, 2022
(86) PCT No.: PCT/EP2022/072395

§ 371 Date: Feb. 2, 2024

(30) Foreign Application Priority Data
Aug. 13, 2021 (DK) PA202170404

(51) Int. Cl. B08B 9/08; B01D 1/28; B01D 21/26; B01D 36/02; B01D 36/04; B01D 61/02; B01D 61/14; B01D 61/58; B08B 9/032; B08B 13/00; C02F 1/00; C02F 1/28; C02F 1/32; C02F 1/38; C02F 1/50; C02F 1/66; C02F 1/76; C02F 1/78; C02F 9/00; C02F 101/30; C02F 103/32; C11D 7/06; C11D 7/08

(52) U.S. Cl. CPC B08B 9/08; B01D 1/28; B01D 21/262; B01D 36/02; B01D 36/045; B01D 61/025; B01D 61/027; B01D 61/145; B01D 61/58; B08B 9/032; B08B 13/00; C02F 9/00; C11D 7/06; C11D 7/08; B08B 2209/032; B08B 2209/08; C02F 1/001; C02F 1/283; C02F 1/32; C02F 1/38; C02F 1/50; C02F 1/66; C02F 1/76; C02F 1/78; C02F 2101/308; C02F 2103/32; C02F 2209/05; C02F 2209/06; C02F 2209/11; C02F 2301/046; C02F 2303/02; C02F 2303/04

(57) ABSTRACT

The present disclosure relates to a clean-in-place (CIP) system and process, wherein minimal or no wastewater is released by the CIP system to a drain. The present disclosure further relates to use of a clean-in-place (CIP) system, wherein the water and cleaning agents used are processed and recycled such that minimal or no wastewater is released to a drain by the system. In particular, the invention relates to a clean-in-place (CIP) system configured to clean one or more objects such as tanks, pipes, pipelines, etc. in fluid communication with the system, the system being further configured to process and recycle one or more cleaning agents and/or water, wherein minimal or no wastewater is released from the system.

The present disclosure relates to a cleaning-in-place (CIP) system and process, wherein minimal or no wastewater is released by the CIP system to a drain. The present disclosure further relates to use of a cleaning-in-place (CIP) system, wherein the water and cleaning agents used are processed and recycled such that minimal or no wastewater is released to a drain by the system.

### BACKGROUND OF INVENTION

Cleaning-in-place (CIP) has been known for decades as a method to clean the interior surfaces of pipes, vessels, pumps, heat exchangers, equipment, filters and associated fittings, without major disassembly. CIP is commonly used for equipment such as piping, tanks, pumps, heat exchangers and fillers. Industries that rely heavily on CIP are typically those requiring high levels of hygiene, such as dairy, beverage, brewing, processed foods, pharmaceutical, and the cosmetics industry.

In the 1970s, CIP plants with return systems started to develop, in order to get a more efficient, consistent and automated cleaning. However, there was essentially no focus on reducing use of water, chemicals and energy and production of wastewater. During the 80s and 90s, CIP plants were developed with water recovery tanks and solids recovery tanks that were intended to be re-used in the production. However, satisfactory results were rarely achieved. During these times, developments of CIP plants that save water, energy and reduce wastewater were typically not the focus of the equipment suppliers, but rather carried out by dairies engineering staff, production staff or external consultants. As incoming water and wastewater discharge prices rise and there is more focus on reducing resource consumption CIP plants that reduce the amount of wastewater and energy are greatly needed. Furthermore, more countries worldwide are tightening their legislation concerning the environment discharge, so the production companies are forced to reduce their environmental footprint.

U.S. Pat. No. 5,888,311 A discloses a process for cleaning processing equipment for beverages or foods including the steps of (a) pumping a cleaning solution from a holding tank through the processing equipment in the absence of a pre-rinsing step, (b) collecting a first portion of the cleaning solution returning from the processing equipment into a recycling tank, (c) returning to the holding tank for the cleaning solution the main portion of the cleaning solution flowing through the processing equipment, (d) subjecting the first portion of the cleaning solution collected into the recycling tank to a separation process to provide a soil-rich concentrate and a low soil content regenerate, (e) transferring the regenerate to the holding tank for the cleaning solution, and (f) disposing of the soil-rich concentrate as waste.

CN 208613225 U discloses a fully automatic CIP system and process where water and cleaning agents being used in the process are processed e.g. by filtering (41) and recycled such that minimal waste water is released to a drain in the process. The process comprises the steps of rinsing one or more objects (14, 15) fluidly connected to a CIP system by pushing forward process water from a process water supply (11) through one or more forward lines (3) to the objects (14, 15), cleaning the one or more objects using one or more cleaning agents.

Existing CIP plants discharge wastewater into the drain. The wastewater may contain a mix of water, chemicals, and solids such as food residuals. Subsequently, the wastewater is typically treated at a wastewater treatment plant. In general, it is cumbersome and expensive to process the wastewater such that it can be returned to the water cycle, e.g. by removing contaminants from wastewater. The reason is that the wastewater is a mix of many different liquids (e.g. chemicals) and solids that need to be separated from the wastewater Therefore, there is a need of a CIP system and process that reduces the amount of discharged wastewater, or one that ideally releases minimal or no wastewater thereby obviating the need of a drain entirely.

### SUMMARY OF INVENTION

The present invention addresses the above-mentioned needs by providing a cleaning-in-place (CIP) system and process, wherein the cleaning agents used are processed and recycled by the system such that minimal or no wastewater is released from the system.

The above-mentioned problem of how to provide a CIP system that releases minimal or no wastewater is solved by providing a cleaning-in-place (CIP) system configured to clean one or more objects (e.g. tanks, pipes, pipelines, etc.) in fluid communication with the system, the system being further configured to process and recycle one or more cleaning agents, wherein minimal or no wastewater is released from the system, the system comprising:
one or more process water tanks for storing water;
at least two tanks for storing cleaning agents, said two tanks comprising:
   a first cleaning agent tank for storing a first cleaning agent comprising one or more chemicals such as sodium hydroxide, and/or for storing used first cleaning agent;
   a second cleaning agent tank for storing a second cleaning agent comprising one or more chemicals such as nitric acid and/or phosphoric acid, and/or for storing used second cleaning agent;
one or more forward lines configured to forward liquid (e.g. process water, the first and/or second cleaning agent) from the system to the object(s) in fluid communication with the system in order to clean or rinse the object(s);
one or more return lines for returning liquid from the object(s) to the system, wherein the first cleaning agent tank and the second cleaning agent tank are configured to receive the used first and second cleaning agent, respectively, from or at least partly from the return lines; and
a plurality of recovery tanks for storing cleaning agents and/or water.

According to an embodiment, the above-mentioned problem of how to provide a CIP system that releases minimal or no wastewater may be solved by providing a cleaning-in-place (CIP) system configured to clean one or more objects (e.g. tanks, pipes, pipelines, etc.) in fluid communication with the system, the system being further configured to process and recycle one or more cleaning agents, wherein minimal or no wastewater is released from the system, the system comprising:
one or more process water tanks for storing process water;
at least two tanks for storing cleaning agents, said two tanks comprising:
at least a first cleaning agent tank for storing a first cleaning agent comprising one or more chemicals such as sodium hydroxide and/or for storing returned/used cleaning agent received from the return line(s);
at least a second cleaning agent tank for storing a second cleaning agent comprising one or more chemicals, such as nitric acid and/or phosphoric acid, and/or for storing returned/used cleaning agent received from the return line(s);
one or more forward lines configured to forward liquid (e.g. process water, clean water, the first and/or second cleaning agent) from the system to the object(s) in fluid communication with the system in order to clean or rinse the object(s);
one or more return lines for returning liquid from the object(s) to the system;
at least four recovery tanks for storing cleaning agents and/or water, said tanks comprising:
   at least one first cleaning agent recovery tank for storing diluted first cleaning agent received from the return line(s);
   at least one second cleaning agent recovery tank for storing diluted second cleaning agent received from the return line(s);
   at least one dirty water recovery tank for storing dirty water (i.e. water comprising soluble and/or insoluble solids) e.g. received from the return line(s);
   at least one clean water recovery tank for storing clean water e.g. received from the return line(s);
a first cleaning agent processing apparatus fluidly connected to the first and/or second cleaning agent tank(s), the first cleaning agent processing apparatus being configured to process used cleaning agent(s), wherein said process includes removing insoluble and/or soluble solids from the used first and/or second cleaning agent(s), whereby processed first/second cleaning agent(s) and optionally dirty water are obtained;
a second cleaning agent processing apparatus fluidly connected to the first and/or second cleaning agent recovery tank(s), the second cleaning agent processing apparatus being configured to separate chemical(s) and water from the diluted first and/or second cleaning agent(s), whereby processed first and/or second cleaning agent(s) and optionally clean water are obtained;
a dirty water processing apparatus fluidly connected to the dirty water recovery tank(s), the dirty water processing apparatus being configured to process the dirty water, in order to separate solids from the dirty water, whereby clean water and optionally concentrated solids are obtained; and
a clean water processing apparatus fluidly connected to the clean water recovery tank(s), the clean water processing apparatus being configured to process clean water received from the clean water recovery tank(s) in order to obtain process water and optionally dirty water,
   wherein the system is configured to:
direct the processed cleaning agent(s) obtained from the first cleaning agent processing apparatus and/or from the second cleaning agent processing apparatus into the first and/or second cleaning agent tank(s) thereby recycling the cleaning agent(s),
direct the clean water obtained from the second cleaning agent processing apparatus and/or from the dirty water processing apparatus into the clean water recovery tank(s), and
direct the process water obtained from the clean water processing apparatus into the process water tank(s) thereby recycling the water such that minimal or no wastewater is released from the system.

An advantage of the presently disclosed CIP system is that the diluted liquids (e.g. water and cleaning agents), which are returned via the return line(s), are recovered while kept separated, i.e. in contrast to discharging said liquids into a drain, where they are mixed. Hence, using the presently disclosed CIP system and process, the water and cleaning agents can be processed (e.g. separation of solids, filtration, disinfection, concentration) and recycled into the process one at a time during the relevant steps of the cleaning process. This is a much more environmentally friendly and cost-effective solution as opposed to processing wastewater (comprising the used liquids) at a wastewater treatment plant.

The CIP system preferably further comprises a monitoring system comprising one or more sensors configured to monitor the system or parts of the system. Preferably, the one or more sensors are configured to monitor the water in the forward and/or return lines, such that the monitoring system is configured to assess e.g. the cleanliness of water in the return line, such that the CIP system can decide whether the water can enter a clean water recovery tank or a dirty water recovery tank.

DK 2020 00433 A1 by the same applicant describes a CIP control surveillance system where all streams forward and return are monitored and accounted for. This application is hereby incorporated herein in its entirety.

The present disclosure further relates to a cleaning-in-place (CIP) process wherein water and cleaning agents used in the process are processed and recycled such that minimal or no wastewater is released to a drain in the process, said process comprising the steps of:
rinsing one or more objects fluidly connected to a CIP system by:
   pushing forward process water from a process water supply (e.g. one or more process water tanks) through one or more forward lines to the object(s); or
   pushing forward clean water from a clean water supply (e.g. a clean water recovery tank) through one or more forward lines to the object(s);
returning the water from the object(s) to one or more water recovery tanks (e.g. clean water recovery tank(s) or a dirty water recovery tank(s)) via one or more return lines from the object(s);
monitoring by one or more sensors one or more parameters of the water in the return line(s);
redirecting the water in the return line(s) to one or more dirty water recovery tanks in case the monitored parameter(s) exceed one or more predetermined thresholds;
processing the dirty water from the dirty water recovery tank(s), in order to obtain clean water, said process comprising the steps of:
   removing insoluble solids from the dirty water;
   separating water and solids (e.g. soluble solids), whereby clean water, and
   optionally concentrated solids, is/are obtained;
returning the clean water to one or more clean water recovery tanks thereby recycling the water used in the process;
processing the clean water from the clean water recovery tank(s) in order to obtain process water, said process comprising the steps of:
   removing soluble and insoluble solids from the clean water;
   removing colour and/or odour from the clean water;
   disinfecting the clean water (e.g. using ozone injection), whereby process water is obtained;
returning the process water to one or more process water tanks thereby recycling the water used in the process;
cleaning the one or more objects using one or more cleaning agents comprising one or more chemicals (e.g. sodium hydroxide and/or nitric acid and/or phosphoric acid) by pushing forward the cleaning agent(s) from one or more cleaning agent tanks via the forward line(s) to the object(s);
returning the used cleaning agent(s) from the object(s) to one or more cleaning agent tanks or to one or more cleaning agent recovery tanks via the return line(s) from the object(s);
processing the used cleaning agent(s) from the cleaning agent tank(s), said process comprising the steps of:
   removing insoluble solids from the used cleaning agent(s), whereby processed cleaning agent(s) and optionally dirty water are obtained;
   optionally removing soluble solids (e.g. salts and minerals) from the used cleaning agent(s);
processing the diluted cleaning agent(s) from the cleaning agent recovery tank(s), said process comprising the step of:
   separating water and chemicals from the diluted cleaning agent(s) received from the cleaning agent recovery tank(s), whereby clean water and processed cleaning agent(s) are obtained;
returning the processed cleaning agent(s) to the cleaning agent tank(s) thereby recycling the cleaning agent(s) used in the process.

The present disclosure further relates to use of a cleaning-in-place (CIP) system as disclosed herein, wherein the water and cleaning agents used are processed and recycled such that minimal or no wastewater is released to a drain by the system.

Accordingly, the presently disclosed CIP system and process provides a significant improvement to existing CIP systems, which discharges large amounts of wastewater to the drain.

### DESCRIPTION OF DRAWINGS

FIG. 1 shows an embodiment of a CIP system according to the present disclosure.

FIG. 2 shows an embodiment of a CIP system according to the present disclosure, wherein the CIP system comprises a first cleaning agent processing apparatus.

FIG. 3 shows an embodiment of a CIP system according to the present disclosure, wherein the CIP system comprises a second cleaning agent processing apparatus.

FIG. 4 shows an embodiment of a CIP system according to the present disclosure, wherein the CIP system comprises a dirty water processing apparatus.

FIG. 5 shows an embodiment of a CIP system according to the present disclosure, wherein the CIP system comprises a clean water processing apparatus for converting the clean water to process water.

### DEFINITIONS

An object is to be understood herein as a component or system, which is connectable to the CIP system such that the object may be cleaned by the CIP process disclosed herein. The object can e.g. be a filter, a pipe, a vessel, a heat exchanger, a tank, an evaporator, a spray drier, a filling machine and associated fittings, as well as any combination of the mentioned objects.

Process water is to be understood herein as water suitable for use in e.g. the final flush of the CIP process and/or water suitable for use as an ingredient for food products. Hence, the quality of the process water needs to be similar to the quality of drinking water, i.e. water that is safe to drink or use for food preparation. The process water may originate from a water treatment plant or the process water may be contained in one or more process water tanks, e.g. in one or more external process water tanks.

Dirty water is to be understood herein as water comprising solids and/or traces of chemicals (e.g. from cleaning agents).

A processing apparatus should be understood herein as one or more units or devices for processing water and/or cleaning agent(s). Hence, a processing apparatus as defined herein can comprise more than one device. The processing apparatus can be the first cleaning agent processing apparatus, the second cleaning agent processing apparatus, the dirty water processing apparatus, and/or the clean water processing apparatus.

Clean water is to be understood herein as water returned from the return lines and/or from any of the processing apparatus, wherein said water may contain traces of solids and/or chemicals. The clean water is not considered as clean as process water, since there is a small risk that the clean water may comprise traces of solids and/or chemicals. Clean water is therefore not redirected into the process water tanks, but instead into a dedicated clean water recovery tank.

A diluted cleaning agent is a cleaning agent that has been mixed with water during the cleaning process and/or the recycling of the cleaning agent(s) used in the cleaning process.

### DETAILED DESCRIPTION OF THE INVENTION

The present disclosure relates to a cleaning-in-place (CIP) system configured to clean one or more objects (e.g. tanks, pipes, pipelines, etc.) in fluid communication with the system, the system being further configured to process and recycle water and one or more cleaning agents, wherein minimal or no wastewater is released from the system.

### Cleaning Agent Tanks

The CIP system may comprise at least two cleaning agent tanks for storing cleaning agents, said two cleaning agent tanks comprising:
at least a first cleaning agent tank for storing a first cleaning agent comprising one or more chemicals such as sodium hydroxide and/or for storing returned/used cleaning agent received from the return line(s) and optionally from the first cleaning agent processing apparatus and/or the second cleaning agent processing apparatus;
at least a second cleaning agent tank for storing a second cleaning agent comprising one or more chemicals, such as nitric acid and/or phosphoric acid, and/or for storing returned/used cleaning agent received from the return line(s) and optionally from the first cleaning agent processing apparatus and/or the second cleaning agent processing apparatus.

Preferably, the first cleaning agent is an alkaline solution, e.g. comprising sodium hydroxide (NaOH), and the second cleaning agent is preferably an acidic solution, e.g. comprising nitric acid (HNO₃) and/or phosphoric acid (H₃PO₄). The CIP system may comprise further tanks e.g. for storing diluted cleaning agents, i.e. cleaning agents that have been mixed with water thereby being diluted. An example of such tanks are the cleaning agent recovery tanks.

### Forward and Return Lines

The CIP system further comprises one or more forward lines configured to forward liquid (such as process water or clean water, or the first and/or second cleaning agent) from the system to the objects (pipes, vessels, etc.) in fluid communication with the system, in order to clean or rinse the object(s). The CIP system further comprises one or more return lines for returning liquid from the object(s) to the system, e.g. to the one or more tanks (e.g. the first and/or second cleaning agent tank) of the system. Preferably, a number of valves are present in the CIP system such as at least one valve for each tank in the system. As an example, such valves may be placed near an inlet or outlet of said tanks or they may be placed on the forward and/or return line(s). The valves are preferably configured for opening/closing the tanks of the system and/or for redirecting a flow of liquid in the forward/return lines. The CIP system may comprise a control system configured to control the one or more valves of the system.

### Recovery Tanks

The CIP system may further comprise one or more recovery tanks, such as water recovery tanks for storing water received from the return line(s) and/or from the processing apparatus and/or cleaning agent recovery tanks for storing cleaning agent(s) received from the return line(s) and/or from the processing apparatus. In a preferred embodiment, the CIP system comprises at least four recovery tanks for storing cleaning agents and/or water, wherein said at least four recovery tanks comprises:
at least one first cleaning agent recovery tank for storing diluted first cleaning agent received from the return line(s);
at least one second cleaning agent recovery tank for storing diluted second cleaning agent received from the return line(s);
at least one dirty water recovery tank for storing dirty water (i.e. water comprising soluble and/or insoluble solids) e.g. received from the return line(s) and/or from the processing apparatus; and
at least one clean water recovery tank for storing clean water e.g. received from the return line(s) and/or processing apparatus.

Used cleaning agent(s) should be understood herein as a cleaning agent(s) that have been used in a step of a CIP process to clean one or more objects (e.g. tanks). The used cleaning agent(s) returned from the object(s) via the return line(s) may comprise solids, e.g. insoluble solids, in which case the used cleaning agent(s) are preferably directed into the first and/or second cleaning agent tank(s). The cleaning agent(s) may further become diluted, since the object(s) may comprise water (e.g. from a previous flush step of the CIP process), and furthermore since some of the chemicals in the cleaning agent(s) are consumed/reacted in the CIP process. Used cleaning agent(s) that are diluted are preferably directed into the cleaning agent recovery tank(s). Subsequently, the used cleaning agent(s) is/are preferably concentrated to reach a desired concentration.

### Process Water Tanks

The CIP system may comprise one or more process water tanks for storing process water. The process water tank(s) may receive the process water from a tap and/or from the clean water processing apparatus, preferably after the water has been filtered and/or disinfected. Preferably, the quality of the water can be assessed by a water quality sensor before the water enters the process water tank(s) to avoid contamination of the process water in the process water tank(s).

### Monitoring System

The CIP system may further comprise a monitoring system comprising one or more sensors configured to monitor the CIP system or parts of the system. Preferably, the monitoring system is configured to monitor the water in the return line(s) in order to assess the cleanliness of the water. Thereby, the system can decide whether the returned water (from the objects) should enter one or more clean water recovery tanks or one or more dirty water recovery tanks. The CIP system may be configured to direct used water returned from the one or more objects into one or more water recovery tanks under one or more predetermined condition(s) monitored by the monitoring system. As an example, the one or more predetermined condition(s) comprise a turbidity threshold value relating to the turbidity of the water and/or an electrical conductivity threshold value relating to the electrical conductivity of the water.

The monitoring system may be used in association with a control system configured to control the CIP system e.g. by controlling the one or more valves of the CIP system, such that liquid in the forward/return lines can be directed into the correct tanks e.g. by setting up predefined threshold values of parameters monitored by the monitoring system. The monitoring system may be configured to control one or more pumps for pumping the liquid passed any open of the valve(s) into the correct tank(s). The sensors of the monitoring system may be selected among the group of: optical sensors, conductivity sensors, density sensors, flow meters, temperature sensors, brix sensors, and/or pH sensors. In one embodiment, the monitoring system comprises an optical sensor configured to measure the turbidity of the water (e.g. measured in ppm) and/or a conductivity sensor configured to measure the electrical conductivity of the water (e.g. measured in μS). The CIP system is preferably configured to compare the measured values (of the turbidity and/or conductivity) with predefined threshold values. In one embodiment, the system is configured to direct the used water into a dirty water recovery tank when the turbidity threshold value and/or the electrical conductivity threshold value is exceeded. The change of the turbidity of the water is due to the presence of suspended and/or dissolved solids in the water, which originates from the one or more objects being cleaned. Examples of typically encountered solids include fat, protein, carbohydrate and mineral deposits e.g. from heat exchangers, fruit fibres and—pieces, cocoa residuals, and coffee grains. The solids may be present as soluble solids or insoluble solids in the returned liquid(s), e.g. the returned water. Hence, the system is able to assess the cleanliness of the water in order to decide whether the used water should be directed into a clean water recovery tank (in case of minute traces of solids) or one or more dirty water recovery tanks (in case predefined threshold values are exceeded).

### First Cleaning Agent Processing Apparatus

In one embodiment, the CIP system comprises at least one first cleaning agent tank for storing a first cleaning agent and at least one second cleaning agent tank for storing a second cleaning agent. The CIP system preferably further comprises a first cleaning agent processing apparatus fluidly connected to the first and/or second cleaning agent tank(s), said first cleaning agent processing apparatus being configured to process used cleaning agent(s), wherein said process includes removing insoluble solids from the used first and/or second cleaning agent(s), whereby processed first/second cleaning agent(s) and dirty water are obtained. The first cleaning agent processing apparatus preferably comprises a first solids separation device (e.g. selected from the group of: clarifier, decanter, UF filtration, inline strainer/rotary screen, and/or combinations thereof) configured to remove insoluble solids from the used cleaning agent(s). The first cleaning agent processing apparatus may further comprise a soluble solids filtration device (e.g. a nano filter, a nano filtration device, or an ultrafiltration (UF) device) configured to remove soluble solids such as salts and minerals from the used cleaning agent(s).

### Second Cleaning Agent Processing Apparatus

In one embodiment, the CIP system comprises a first cleaning agent recovery tank for storing used and/or diluted first cleaning agent received from the return line(s) and a second cleaning agent recovery tank for storing used and/or diluted second cleaning agent received from the return line(s). The CIP system preferably further comprises a second cleaning agent processing apparatus fluidly connected to the first cleaning agent recovery tank and/or second cleaning agent recovery tank, the second cleaning agent processing apparatus configured to process the used first and/or second cleaning agent, in order to separate chemical(s) and water contained in said cleaning agent(s). As a result, the cleaning agent(s) are concentrated and can be returned to the cleaning agent tank(s). The separated water can be returned as clean water to the clean water recovery tank(s).

The second cleaning agent processing apparatus may preferably comprise a water/chemical separation device configured to separate water and chemical(s) from the recovered/diluted first and/or second cleaning agents. The water/chemical separation device serves two purposes: To separate the water and the chemicals and to concentrate the cleaning agent(s) in order to obtain a desired concentration of the cleaning agent(s). Many different types of equipment may be suitable for this purpose. As an example, the water/chemical separation device may be selected from the group of: reverse osmosis (RO) membrane plants, thermal vapour recompression (TVR) evaporators, mechanical vapour recompression (MVR) evaporators, and/or combinations thereof. The concentrated cleaning agent(s) may be returned to the first/second cleaning agent tank(s), and the water may be directed into the clean water recovery tank.

The second cleaning agent processing apparatus may further comprise a second solids separation device configured to separate insoluble solids (e.g. food residuals) from the recovered first and/or second cleaning agent. The second solids separation device can be any device suitable for this purpose. As an example, the second solids separation device may be selected from the group of: inline strainers, rotary screens, decanter centrifuges, and clarifier centrifuges. In particular, a clarifier centrifuge is preferred in the presently disclosed CIP system, since it delivers dry solids as solid waste. The solid waste from the second solids separation device may be collected in a solid waste container or sent to the dirty water recovery tank(s). The solid waste may be useful as animal food, land filling, and/or dried and burned in a biomass boiler. In case the CIP system comprises a second solids separation device, said device is preferably fluidly connected to the water/chemical separation device such that output of the second solids separation device is connected to the input of the water/chemical separation device. However, most embodiments the CIP system does not comprise the second solids separation device, which may be considered optional.

The CIP system may further comprise a sterilization device configured to sterilize the chemicals (e.g. by ultra-high-temperature (UHT) processing, and/or ozone injection, and/or UV treatment) separated by the water/chemical separation device, said sterilization device fluidly connected to the second cleaning agent processing apparatus.

### Dirty Water Processing Apparatus

The CIP system preferably further comprises a dirty water processing apparatus fluidly connected to the one or more dirty water recovery tanks for storing dirty water, wherein the dirty water processing apparatus is configured to process the dirty water in order to separate/remove solids (e.g. insoluble solids) from the dirty water. The dirty water is preferably automatically directed into the one or more dirty water recovery tanks in case certain predefined threshold values (e.g. relating to the turbidity of the water) are exceeded, as explained further elsewhere herein.

The dirty water processing apparatus may comprise a third solids separation device configured to remove insoluble solids (e.g. food residuals) from the dirty water. The third solids separation device may be similar to the second solids separation device. Therefore, the third solids separation device may be selected from the group of: inline strainers, rotary screens, decanter centrifuges, and clarifier centrifuges. The third solids separation device typically has two outputs: solid waste, which is preferably directed into a solid waste container for holding solid waste, and dirty water comprising remaining solids such as dissolved solids.

The dirty water processing apparatus may further comprise a water/solids separation device configured to separate the remaining solids (e.g. dissolved solids) from the recovered dirty water. A pH adjustment of the dirty water prior to the water/solids separation may be advantageous especially if the solids are from fermented products when the dirty water can be acidic. The pH value of the dirty water when entering the water/solid separation should preferably be 6.6 to 7.4, more preferably 6.7 to 6.8. A PH sensor positioned prior to the water/solids separation e.g. in the dirty water tank for measuring the pH value of the dirty water is preferable as well as an acid/base source for lowering/raising the pH value before the water/solid separation. The water/solids separation device may be selected from the group of: reverse osmosis (RO) membrane plants, thermal vapour recompression (TVR) evaporators, mechanical vapour recompression (MVR) evaporators, and/or combinations thereof. A PH within the range of 6.6 to 7.4 is advantageous, since the lifetime and/or processing time of the RO, of the TVR and/or of the MVR will be increased, since deposits and blocked membranes are avoided. The water/solids separation device is preferably fluidly connected to the third solids separation device such that output of the third solids separation device is connected to the input of the water/solids separation device. The water/solids separation device has two outputs: clean water, which has been separated by the device and a solids solution (i.e. a liquid comprising solids). The former is preferably directed into the clean water recovery tank(s). The solids solution is preferably directed into one or more heat treatment tanks and/or into one or more concentrate solids tanks.

The dirty water processing apparatus is preferably configured to recirculate the solids solution from the water/solids separation device and into the one or more dirty water recovery tanks. From here, the solids solution is subsequently directed through the third and water/solids separation devices again, whereby the concentration of the solids solution is increased. This may be repeated a number of times until the solids solution has reached a desired concentration. This may be determined by the CIP system by the use of the monitoring system. In one embodiment, the monitoring system comprises a brix sensor configured to determine the concentration of the solids solution in degree Brix (° Bx) and/or a density sensor configured to determine the density of the solids solution. The brix sensor and/or the density sensor may be placed near the output of the water/solids separation device. Hence, the purpose of the dirty water processing apparatus is twofold. The main purpose is to separate water and solids from the dirty water. Another purpose is to concentrate the solids solution to reach a predefined concentration.

In one embodiment, the system can be configured for adjusting the pH value of the dirty water, preferably prior to the water/solids separation device.

In one embodiment, the system can comprise an alkali container configured for adding an alkali solution to the dirty water and/or an acid container configured for adding an acidic solution to the dirty water.

In one embodiment, the system can comprise a pH sensor for determining the pH value of the dirty water, preferably the pH sensor is positioned prior to a water/solids separation device.

When the pH value of the dirty water is determined, it will be possible to calculate how much alkali solution or acidic solution that needs to be added to the dirty water so that pH value of the dirty water is changed to the desired pH value.

Once the solids solution has reached a certain predefined concentration, it is preferably directed into one or more heat treatment tanks, like one or more heat treatment tanks, fluidly connected to the dirty water processing apparatus. The one or more heat treatment tanks are preferably configured such that the solids solution from the dirty water processing apparatus is heat-treated for eliminating pathogens, and optionally also fermented, in order to obtain e.g. animal food, solid waste, fertilizer or a bio-fuel product. The fermentation increases the shelf life of the solids solution, which is beneficial especially if the solids solution is to be used as animal food. Accordingly, the output of the one or more heat treatment tanks is a concentrated, heat-treated, and optionally fermented solids solution, which is suitable as e.g. animal food, solid waste, fertilizer or a bio-fuel product. The output solids solution may be dispatched into a container or collection truck. As an alternative to the heat treatment tank(s), the heat treatment of the solids solution may be performed inline, so that the solids solution is heat-treated continuously saving time. Preferably, the solids solution is first concentrated and then heat-treated.

The CIP system may further comprise one or more clean water recovery tank(s) for storing clean water that has been separated by the dirty water processing apparatus and/or by the second cleaning agent processing apparatus, and/or from CIP return line(s). The system may further be configured to receive raw water (e.g. from a fresh water supply) and separating unwanted substances from said raw water.

### Clean Water Processing Apparatus

The CIP system preferably further comprises a clean water processing apparatus configured to further process the clean water from the clean water recovery tank(s) and/or from the second cleaning agent processing apparatus and/or from the dirty water processing apparatus in order to obtain process water. The clean water processing apparatus is fluidly connected to the clean water recovery tank(s). Some of the water in the clean water recovery tank can preferably be kept in the clean water recovery tank to be used for a pre-flush and/or an intermediate flush of the object.

The clean water processing apparatus is preferably configured to remove soluble and/or insoluble solids from the clean water in e.g. a soluble/insoluble solids separation device. This may be achieved using inline filter/strainers for removing large particles, decanter/clarifier centrifuges for removing smaller particles, active coal filters with subsequent filter bags such as one or more 5 micron filter bags, and/or one or more 1 micron filter bags, or other filters (e.g. walnut shell filters, sand filters, etc.), RO and or nano filtration and/or combinations thereof. The clean water processing apparatus is preferably further configured to remove colour and/or odour from the water e.g. using an advanced oxidation process (AOP) and/or using active coal filters in e.g. colour/odour removal device, wherein the active coal filters have subsequent filter bags such as one or more 5 micron filter bags, and/or one or more 1 micron filter bags. The unwanted colour of the clean water may arise from production lines using natural or artificial colours (e.g. for ice cream, yoghurt, etc.), from coffee extraction lines, or from other sources. The unwanted odour of the clean water may e.g. arise from production lines using natural or artificial flavours and/or from the product itself.

The clean water processing apparatus may comprise a filtration system, which can be part of the colour/odour removal device or positioned just after the colour/odour removal device, wherein the filtration system is configured for filtering clean water. The filtration system may comprise one or more filters, optionally a plurality of different filters for filtering water. From here, the water is preferably directed through the filtration system, whereby the water is filtered. The filtration system may comprise any of the following filters: pre-filter, active coal filter with subsequent filter bags such as 5 micron filter bags and 1 micron filter bags, UV filter, and/or combinations thereof. In one embodiment, the filtration system comprises a pre-filter, an active coal filter with subsequent filter bags such as one or more 5 micron filter bags, and/or one or more 1 micron filter bags, a UV filter or advance oxidation or ozone injection.

The clean water processing apparatus is preferably further configured to disinfect the water e.g. using any of: ozone injection, UV treatment, advanced oxidation, chemicals e.g. chlorination, quaternary ammonium, iodine disinfectants and/or ultra-high temperature processing (UHT). For the presently disclosed CIP system and process, ozone injection is preferred to disinfect the water. The quality of the process water, which is discharged from the clean water processing apparatus, is preferably assessed using a water quality sensor configured to assess water quality. The water quality sensor can be a conductivity sensor, and/or temperature sensor, and/or turbidity sensor, and/or pH sensor, or any combination of these sensors. The water quality sensor can also determine e.g. biochemical oxygen demand (BOD), chemical oxygen demand (COD), dissolved oxygen demand (DOC) and/or total organic carbon (TOC) and others. One example of such a water quality sensor is provided by Proteus Instruments, Stoke Prior, Worcestershire, UK.

In case the quality of the obtained process water is inferior, the water is preferably directed back to the clean water recovery tank(s). In case the quality is accepted, the process water may be directed into the one or more process water tanks for storing process water, said process water tank(s) being fluidly connected to the clean water processing apparatus. From here, the process water can re-enter a CIP process e.g. the final flush of a CIP process. The process water may also be used for many other purposes, such as an ingredient in food products, water hosing stations, drinking water, process equipment, utility equipment, and/or domestic use, etc.

### Emergency Tank

The CIP system may further comprise an emergency tank for storing liquid. The emergency tank may be used e.g. in case of power failures or in case of faults of the control system/monitoring system. In such cases, any liquid contained in the system (e.g. in the forward lines, return lines) or in the objects connected to the system, may be directed into the emergency tank. The liquid in the emergency tank can be disposed at an external wastewater treatment plant by means of a container or truck. Alternatively, the liquid in the emergency tank can be returned to the CIP plant after a quality check of the liquid in the emergency tank has been determined, and if the quality check allows a return of the liquid to the CIP plant.

### Cleaning-In-Place (CIP) Process

The present disclosure further relates to a cleaning-in-place (CIP) process wherein water and cleaning agents used in the process are recycled such that minimal or no wastewater is released to a drain by the process. The disclosed CIP process is further described in the following.

A typical cleaning-in-place process is described in DK 2020 00433 A1 by the same applicant, and generally comprises a number of steps to clean a number of object(s) connected to the CIP system. Typically, the first step is the pre-flush, wherein water (e.g. from a fresh water supply or from the clean water recovery tank) is flushed through the object(s) via the forward line(s) and returned to the CIP system via the return line(s). The next step is typically a caustic flush, wherein a first cleaning agent (e.g. an alkaline solution comprising sodium hydroxide) is pushed forward from the one or more cleaning agent tanks via the forward line(s) to the object(s). The first cleaning agent is then returned from the object(s) via the return line(s) and directed into the first cleaning agent tank(s) or into the first cleaning agent recovery tank(s). Subsequently, the intermediate flush is typically done in order to clear the object(s) and CIP lines (forward line(s), return line(s)) from the first cleaning agent. The intermediate flush may be returned to the first cleaning agent recovery tank(s). The intermediate flush can be done using water from a process water supply or from the clean water recovery tank. Next, an acid flush is typically done, wherein a second cleaning agent (e.g. an acidic solution comprising nitric acid and/or phosphoric acid) is pushed forward from the one or more cleaning agent tanks via the forward line(s) to the object(s). The second cleaning agent is then returned from the object(s) via the return line(s) and directed into the second cleaning agent tank(s) or into the second cleaning agent recovery tank(s). Next, a final flush is typically done, wherein process water is forced through the system and object(s) to perform a final rinse of the object(s). The process water can originate from a process water supply such as one or more process water tanks. The process water is preferably directed into one or more water recovery tanks (e.g. clean water recovery tanks and/or dirty water recovery tanks) or one of the cleaning agent recovery tanks after being returned via the return line(s) from the object(s).

### Monitoring the CIP Process

The cleaning-in-place process as disclosed herein is preferably monitored by the monitoring system described in relation to the CIP system herein. Hence, the pre-flush step is preferably monitored by at least one sensor such as an optical sensor configured to determine the turbidity of the water returned from the object(s). At the beginning of the pre-flush step the remaining water left after the last CIP final flush in the return line will typically be transparent, then the water will typically comprise suspended solid matter and thereby be somewhat non-transparent, which can be identified by e.g. an optical sensor. During the pre-flush step, the water will typically become more transparent, due to the objects being rinsed. Preferably, the CIP process comprises the step of directing dirty water (i.e. water comprising suspended solid matter) into one or more dirty water recovery tank(s) as long as a predefined turbidity threshold is exceeded, which is monitored by the monitoring system (e.g. an optical sensor). Once the threshold is no longer exceeded, the water can be considered clean, and is preferably directed into one or more clean water recovery tank(s) instead of the dirty water recovery tank(s).

Similarly, the monitoring system is preferably configured to monitor the used cleaning agents in the return line(s), i.e. used cleaning agents. Specifically, the monitoring system may comprise one or more conductivity sensors configured to determine the concentration of the cleaning agents in the return line(s). Thereby, the CIP system can decide whether the used cleaning agents should be directed into the cleaning agent tank(s) or the cleaning agent recovery tank(s) for storing diluted cleaning agent(s). If the concentration of the cleaning agent in the used cleaning agent is equal or above a predefined concentration the used cleaning agents can advantageously be directed into the cleaning agent tank(s), while if the concentration of the cleaning agent in the used cleaning agent is below the predefined concentration the used cleaning agents can advantageously be directed into the cleaning agent recovery tank(s), Typically, at the beginning of the caustic flush, the first cleaning agent (e.g. alkaline solution) will be diluted due to the presence of water from the pre-flush step. Therefore, the used first cleaning agent can initially be directed into the cleaning agent recovery tank(s), and later in the caustic flush be directed into the cleaning agent tank(s). Similarly, initially during an intermediate flush there will be cleaning agents present. Therefore, the water should be directed into one or more cleaning agent recovery tank(s). When the water is considered clean enough (by the monitoring system), it can be directed into the one or more clean water recovery tank(s).

### Processing Water and Cleaning Agents

The presently disclosed CIP system and associated CIP process provides a method to process the used water and cleaning agents, whereby they can be re-used in another CIP process. Details of this process are given in the following.

As mentioned elsewhere in this description, the CIP system preferably comprises one or more dirty water recovery tanks for storing water that is considered dirty, i.e. water comprising solids (insoluble and/or soluble). The CIP process preferably comprises the step of processing the dirty water from the dirty water recovery tank(s), in order to obtain clean water. This process may comprise the steps of: removing insoluble solids from the dirty water (e.g. using inline filters and/or strainers for removing large particles and decanter/clarifier centrifuges for removing smaller particles), and separating water and solids (e.g. using MVR evaporator, TVR evaporator, and/or RO filtration), whereby clean water is obtained. The clean water may then be directed into the clean water recovery tank(s). The step of removing insoluble solids may be done using the third solids separation device described elsewhere. The step of separating water and solids may be done using the water/solids separation device described elsewhere. As mentioned above, a pH adjustment of the dirty water prior to the water/solids separation may be advantageous especially if the solids are from fermented products.

The CIP process preferably further comprises the step of processing the clean water from the clean water recovery tank(s) in order to obtain process water. This process may comprise the steps of
removing soluble and insoluble solids from the clean water (e.g. using a combination of equipment selected from the group of: inline filters/strainers, decanter centrifuges, clarifier centrifuges, active coal filters with subsequent filter bags such as one or more 5 micron filter bags, and/or one or more 1 micron filter bags, or other filters (e.g. walnut shell filters or sand filters) or RO/Nano filtration;
removing colour and odour from the clean water (e.g. using active coal filters with subsequent filter bags such as one or more 5 micron filter bags, and/or one or more 1 micron filter bags and/or advanced oxidation processes); and
disinfecting the clean water (e.g. using any of: ozone injection, UV light, advanced oxidation, UHT heat treatment, disinfection chemicals, and/or combinations thereof), whereby process water is obtained.

The CIP process preferably further comprises the step of returning the used cleaning agent(s) from the object(s) to the one or more cleaning agent tanks and/or to the one or more cleaning agent recovery tanks via the return line(s).

The CIP process preferably further comprises the step of processing the used cleaning agent(s) from the cleaning agent tank(s) in order to obtain processed cleaning agent(s). The process may comprise the steps of: removing insoluble solids from the used cleaning agent(s) (e.g. using a clarifier centrifuge, a decanter centrifuge, ultrafiltration, inline strainer/rotary screen, and/or combinations thereof), whereby processed cleaning agent(s) are obtained; and optionally removing soluble solids (e.g. salts and minerals) from the used cleaning agent(s) (e.g. using nano filtration). The processed cleaning agent tank(s) may be directed into the cleaning agent tank(s).

The CIP process preferably further comprises the step of processing the used cleaning agent(s) from the cleaning agent recovery tank(s) in order to obtain processed cleaning agent(s), said processing comprising the steps of: separating water and chemicals from the diluted cleaning agent(s) received from the cleaning agent recovery tank(s), whereby clean water and processed cleaning agent(s) are obtained; and optionally sterilizing the cleaning agent(s) (e.g. by ultra-high-temperature processing). The process may optionally include the step of separating insoluble solids from the used cleaning agent(s), wherein said step is performed prior to separating water and chemicals from the used cleaning agent(s).

The CIP process preferably further comprises the step of returning the processed cleaning agent(s) to the cleaning agent tank(s) thereby recycling the cleaning agent(s) used in the process. The step of removing insoluble solids from the used cleaning agent(s) may be done using the second solids separation device. The step of separating water and chemicals from the used cleaning agent(s) is preferably done using the water/chemical separation device. These devices are explained in further detail in relation to the CIP system.

Preferably, the CIP process comprises the step of recirculating a solids solution from the water/solids separation device into the one or more dirty water recovery tanks in order to increase the concentration of the solids solution. This may be repeated a number of times until the solids solution has reached a desired concentration. The concentration may be monitored by a brix sensor and/or a density transmitter configured to determine the concentration of the solids solution in degree Brix (° Bx) and/or density of solids relative volume of solution. The CIP process preferably further comprises the step of directing the solids solution into one or more heat treatment tanks configured for eliminating pathogens, wherein the heat treatment tank(s) is/are fluidly connected to the dirty water processing apparatus, once the solids solution has reached a certain predefined concentration. The CIP process preferably further comprises the step of concentrating, heat treating and optionally fermenting the solids solution using the one or more heat treatment tanks, whereby e.g. animal food, solid waste, fertilizer or a bio-fuel product is obtained.

The described CIP process may be performed using the CIP system as disclosed herein.

### DETAILED DESCRIPTION OF THE DRAWINGS

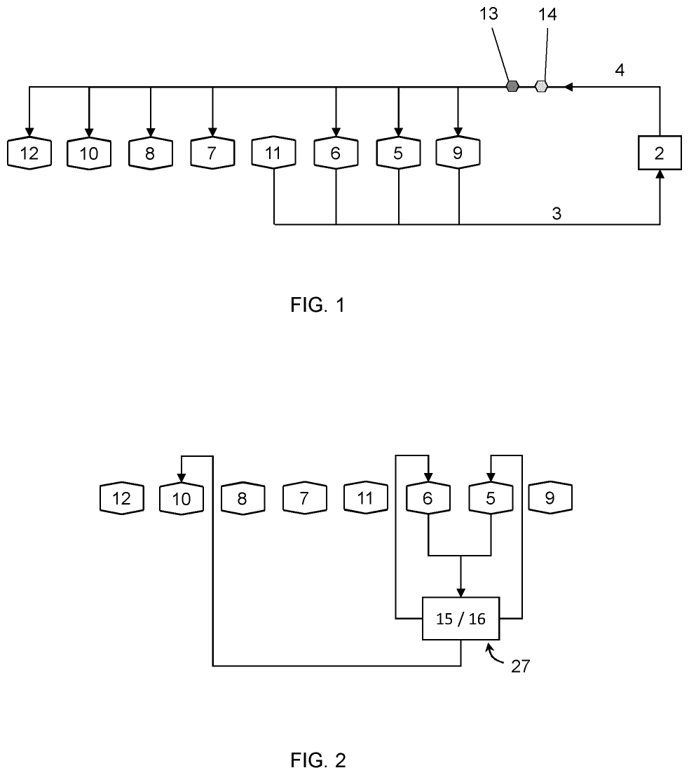

FIG. 1 shows an embodiment of a CIP system according to the present disclosure, wherein the CIP system comprises a plurality of tanks for storing cleaning agents and a plurality of recovery tanks for storing recovered cleaning agents and/or water. The CIP system comprises: one or more process water tanks 11 for storing process water, a first cleaning agent tank 5 for storing a first cleaning agent, a second cleaning agent tank 6 for storing a second cleaning agent, a clean water recovery tank 9 for storing clean water, a first cleaning agent recovery tank 7 for storing diluted/used first cleaning agent, a second cleaning agent recovery tank 8 for storing diluted/used second cleaning agent, and one or more dirty water recovery tanks 10 for storing dirty water. The CIP system is fluidly connected to one or more objects 2, such as pipes, vessels, filters, equipment, heat exchangers via one or more forward lines 3 for forwarding liquid to the object(s) and return lines 4 for returning liquid from the object(s). The CIP system may further comprise one or more sensors (e.g. optical sensors 13 and/or conductivity sensors 14) configured to monitor the water/cleaning agent(s) in the return line(s) in order to determine the cleanliness of the water/cleaning agent(s). In case the returned water is considered dirty (e.g. if the water is non-transparent due to the presence of suspended particulates), the CIP system is preferably configured to direct the water into the dirty water recovery tanks. In case at least one of the above-mentioned predefined threshold values of the returned/used cleaning agent(s) has been reached and/or exceeded, the returned/used cleaning agent(s) is/are preferably returned to the first and/or second cleaning agent tanks 5, 6. In case the returned/used cleaning agent(s) is/are diluted, the returned/used cleaning agent(s) is/are preferably returned to the cleaning agent recovery tank(s) 7, 8.

FIG. 2 shows an embodiment of a CIP system according to the present disclosure, wherein the CIP system comprises the same tanks as the embodiment shown in FIG. 1. However, in this embodiment, the CIP system further comprises a first cleaning agent processing apparatus 27 fluidly connected to the cleaning agent tank(s) 5, 6, said apparatus 27 configured to process used cleaning agent(s), wherein said process includes removing insoluble solids from the used first and/or second cleaning agent(s), whereby processed first/second cleaning agent(s) and dirty water are obtained. The processed first/second cleaning agent(s) are preferably directed into the first cleaning agent tank 5 and/or the second cleaning agent tank 6, whereas the dirty water is preferably directed into the dirty water recovery tank(s) 10. The first cleaning agent processing apparatus 27 comprises a first solids separation device 15 (e.g. selected from the group of: clarifier, decanter, UF filtration, inline strainer/rotary screen, and/or combinations thereof) configured to remove insoluble solids from the used cleaning agent(s). The first cleaning agent processing apparatus 27 may further comprise a soluble solids filtration device 16 (e.g. a nano filter, a nano filtration device, or an ultrafiltration (UF) device) configured to remove soluble solids such as salts and minerals from the used cleaning agent(s).

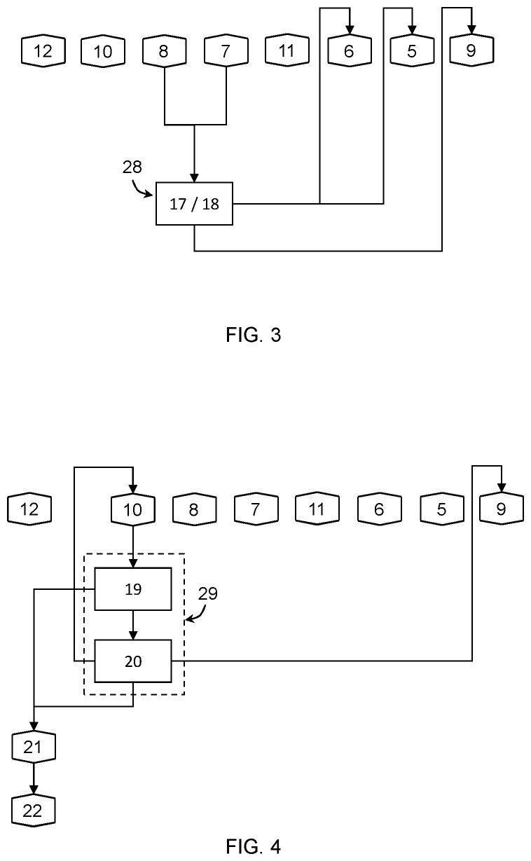

FIG. 3 shows an embodiment of a CIP system according to the present disclosure, wherein the CIP system comprises the same tanks as the embodiment shown in FIG. 1. However, in this embodiment, the CIP system further comprises a second cleaning agent processing apparatus 28 fluidly connected to the cleaning agent recovery tank(s) 7, 8, said apparatus 28 configured to process diluted cleaning agent(s), whereby processed (e.g. concentrated) cleaning agent(s) and clean water are obtained. The processed/concentrated cleaning agent(s) may be directed into the first/second cleaning agent tank(s) 5, 6, and the clean water may be directed into the clean water recovery tank(s) 9. The second cleaning agent processing apparatus 28 comprises a water/chemical separation device 18 configured to separate the chemical(s) and water contained in said used cleaning agent(s), whereby the diluted cleaning agent(s) are concentrated (e.g. to a similar concentration as the initial concentration of the cleaning agent(s)). The water/chemical separation device 18 may be selected from the group of: MVR evaporator, TVR evaporator, RO filtration, and/or combinations thereof. The second cleaning agent processing apparatus 28 may optionally further comprise a second solids separation device 17 configured to separate insoluble solids from the used cleaning agent(s). The second solids separation device 17 may be selected from the group of: inline strainers, rotary screens, decanter centrifuges, and/or clarifier centrifuges.

FIG. 4 shows an embodiment of a CIP system according to the present disclosure, wherein the CIP system comprises the same tanks as the embodiment shown in FIG. 1. However, in this embodiment, the CIP system further comprises a dirty water processing apparatus 29 fluidly connected to the dirty water recovery tank(s) 10. The dirty water recovery tank(s) 10 may comprise a pH sensor for measuring the pH value of the dirty water. The dirty water recovery tank(s) 10 may comprise pH adjustment for adjusting the pH value of the dirty water before the dirty water is let further to the dirty water processing apparatus 29. The pH adjustment may comprise an alkali container configured for adding an alkali solution to the dirty water if the pH sensor indicates that and/or an acid container configured for adding an acidic solution to the dirty water if the pH sensor indicates that. The alkali container may have an alkali valve and/or an alkali pump for controlling addition of the alkali solution to the dirty water. The acid container may have an acid valve and/or an acid pump for controlling addition of the acid solution to the dirty water. The apparatus 29 is configured to process the dirty water in order to separate solids from the dirty water, whereby clean water and optionally concentrated solids are obtained. The clean water is preferably directed into the clean water recovery tank(s) 9. The dirty water processing apparatus 29 may comprise a third solids separation device 19 and a water/solids separation device 20. The third solids separation device 19 is configured to remove insoluble solids from the dirty water received from the dirty water recovery tank(s) 10. The third solids separation device 19 may comprise equipment selected from the group of: inline filters, inline strainers, rotary screens, decanter centrifuges, clarifier centrifuges, and/or combinations thereof. The inline filters/strainers are useful for removing large particles, and the decanter/clarifier centrifuges are useful for removing smaller particles. Therefore, the third solids separation device 19 may advantageously comprise a combination of an inline filter/strainer and a decanter/clarifier centrifuge. The separated insoluble solids from the third solids separation device 19 may be collected as solid waste, which may subsequently be used in animal food, solid waste, fertilizer, or bio-fuel product.

Alternatively, the separated insoluble solids may be collected in one or more heat treatment tank(s) 21 or concentrate solids tank(s) 22. The separated dirty water (e.g. comprising soluble solids) is preferably directed into a water/solids separation device 20, which is configured to separate water and solids, whereby a concentrated solids solution (e.g. a thick slurry) is obtained along with clean water. The clean water is preferably directed into the clean water recovery tank(s) 9. The solids solution may be directed into the one or more heat treatment tank(s) 21 configured to heat-treat the solids solution for eliminating pathogens in order to prepare e.g. animal food, solid waste, fertilizer or a bio-fuel product. The heat treatment may alternatively be performed inline instead of in the heat treatment tank(s) 21. Optionally, the solids solution may additionally be fermented. The concentrated, heat treated (and optionally fermented) solids solution may be dispatched into one or more concentrate solids tank(s) 22.

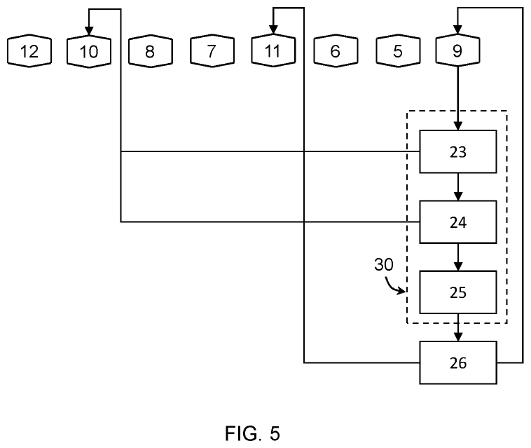

FIG. 5 shows an embodiment of a CIP system according to the present disclosure, wherein the CIP system comprises the same tanks as the embodiment shown in FIG. 1. However, in this embodiment, the CIP system further comprises a clean water processing apparatus 30 fluidly connected to the clean water recovery tank(s) 9, said clean water processing apparatus 30 configured to process clean water received from the clean water recovery tank(s) 9 in order to obtain process water. The process water is preferably directed into the process water tank(s) 11. Preferably, the CIP system comprises a water quality sensor 26 configured to assess the quality of the obtained process water. In case the water quality is inferior, the water obtained from the clean water processing apparatus 30 may be directed back into the clean water recovery tank(s) 9. In case the water quality is accepted, the water obtained from the clean water processing apparatus 30 may be directed into the process water tank(s) 11 for storing process water. The clean water processing apparatus 30 may comprise soluble/insoluble solids separation device 23, a colour/odour removal device 24, and a disinfection device 25. Preferably, the clean water processing apparatus comprises all three. The soluble/insoluble solids separation device 23 may comprise equipment selected from the group of: inline filter/strainers for removing large particles, decanter/clarifier centrifuges for removing smaller particles, active coal filters with subsequent filter bags such as one or more 5 micron filter bags, and/or one or more 1 micron filter bags, or other filters (e.g. walnut shell filters, sand filters, etc.), reverse osmosis (RO) filtration, and/or combinations thereof. The colour/odour removal device 24 is configured to remove colour and/or odour from the water, and may comprise active coal filters with subsequent filter bags such as one or more 5 micron filter bags, and/or one or more 1 micron filter bags, and/or be configured to conduct advanced oxidation processes (AOPs). The disinfection device 25 is configured to disinfect the water using any of the following disinfection processes: ozone injection, UV light, advanced oxidation processes, UHT heat treatment, and/or combinations thereof. Alternatively, the disinfection device 25 may utilize various disinfection chemicals, such as e.g. chlorine, quaternary ammonium, or iodine disinfectants, to disinfect the water. Once the water is disinfected, the quality of the water is preferably assessed by the water quality sensor 26.

### REFERENCE NUMERALS

1. CIP system
2. Object(s)
3. Forward line(s)
4. Return line(s)
5. First cleaning agent tank(s)
6. Second cleaning agent tank(s)
7. First cleaning agent recovery tank(s)
8. Second cleaning agent recovery tank(s)
9. Clean water recovery tank(s)
10. Dirty water recovery tank(s)
11. Process water tank(s)
12. Emergency tank(s)
13. Optical sensor
14. Conductivity sensor
15. First solids separation device
16. Soluble solids filtration device
17. Second solids separation device
18. Water/chemical separation device
19. Third solids separation device
20. Water/solids separation device
21. Heat treatment tank(s) or inline heat treatment
22. Concentrate solids tank(s)
23. Soluble/insoluble solids separation device
24. Colour/odour removal device
25. Disinfection device
26. Water quality sensor
27. First cleaning agent processing apparatus
28. Second cleaning agent processing apparatus
29. Dirty water processing apparatus
30. Clean water processing apparatus

1. A clean-in-place (CIP) system configured to clean one or more objects such as tanks, pipes, pipelines, in fluid communication with the system, the system being further configured to process and recycle one or more cleaning agents and/or water, wherein minimal or no wastewater is released from the system, the system comprising:
one or more process water tanks for storing water;
at least two tanks for storing cleaning agents, said two tanks comprising:
a first cleaning agent tank for storing a first cleaning agent comprising one or more chemicals such as sodium hydroxide, and/or for storing used first cleaning agent;
a second cleaning agent tank for storing a second cleaning agent comprising one or more chemicals such as nitric acid and/or phosphoric acid, and/or for storing used second cleaning agent;
one or more forward lines configured to forward liquid process water, the first and/or second cleaning agent from the system to the one or more object in fluid communication with the system in order to clean or rinse the one or more object;
one or more return lines for returning liquid from the one or more object to the system, wherein the first cleaning agent tank and the second cleaning agent tank are configured to receive the used first and second cleaning agent, respectively, from or at least partly from the return lines; and
a plurality of recovery tanks for storing cleaning agents and/or water.

2. The system according to claim 1, wherein the first cleaning agent is an alkaline solution comprising sodium hydroxide.

3. The system according to claim 1, wherein the second cleaning agent is an acidic solution comprising nitric acid and/or phosphoric acid.

4. The system according to claim 1, wherein the plurality of recovery tanks for storing cleaning agents and/or water comprises:
a first cleaning agent recovery tank for storing used and/or diluted first cleaning agent received from the one or more return line;
a second cleaning agent recovery tank for storing used and/or diluted second cleaning agent received from the one or more return line; and
a dirty water recovery tank for storing dirty water received from the one or more return line.

5. The system according to claim 1, wherein the system further comprises a clean water recovery tank for storing clean water received from the one or more return lines.

6. The system according to claim 1, wherein the system further comprises one or more water recovery tanks for storing dirty water, clean water, and/or process water.

7. The system according to claim 1, wherein the system further comprises a monitoring system comprising one or more sensors configured to monitor the system or parts of the system.

8. The system according to claim 7, wherein the one or more sensors are selected among the group of optical sensors, conductivity sensors, density sensors, flow meters, temperature sensors, brix sensors, and/or pH sensors.

9. The system according to claim 7, wherein the sensors are configured to monitor the water, the first cleaning agent and/or the second cleaning agent in the one or more return lines.

10. The system according to claim 7, wherein the monitoring system comprises an optical sensor configured to measure the turbidity of the water and/or a conductivity sensor configured to measure the electrical conductivity of the water.

11. The system according to claim 7, wherein the system is configured to direct the used water from the one or more objects into the plurality of recovery tank under one or more predetermined condition monitored by the monitoring system.

12. The system according to claim 11, wherein the one or more predetermined condition comprise a turbidity threshold value relating to the turbidity of the water and/or an electrical conductivity threshold value relating to the electrical conductivity of the water.

13. The system according to claim 12, wherein the system is configured to direct the used water into the recovery tank when the turbidity threshold value and/or the electrical conductivity threshold value is exceeded.

14. The system according to claim 1, wherein the system further comprises a first cleaning agent processing apparatus fluidly connected to the first and/or second cleaning agent tank, the first cleaning agent processing apparatus being configured to process used cleaning agent, whereby processed first and/or second cleaning agent and dirty water are obtained.

15. The system according to claim 14, wherein the first cleaning agent processing apparatus comprises a first solids separation device selected from the group of: clarifier centrifuge, decanter centrifuge, UF filtration, inline strainer, rotary screen, and/or combinations thereof.

16. The system according to claim 14, wherein the first cleaning agent processing apparatus further comprises a soluble solids filtration device configured to remove soluble solids such as salts and minerals from the cleaning agent by nano filtration.

17. The system according to claim 1, wherein the system further comprises a second cleaning agent processing apparatus fluidly connected to the first cleaning agent recovery tank and/or second cleaning agent recovery tank, the second cleaning agent processing apparatus configured to process the first and/or second cleaning agents in order to separate chemical and water contained in said cleaning agents.

18. The system according to claim 17, wherein the second cleaning agent processing apparatus is further configured to separate insoluble solids such as food residuals from the used first and/or second cleaning agent.

19. The system according to claim 17, wherein the second cleaning agent processing apparatus comprises a second solids separation device configured to separate insoluble solids such as food residuals from the recovered first and/or second cleaning agent.

20. The system according to claim 17, wherein the second cleaning agent processing apparatus comprises a water/chemical separation device configured to separate water and chemical(s) from the used first and/or second cleaning agents.

21. The system according to claim 17, wherein the second cleaning agent processing apparatus comprises a sterilization device configured to sterilize the chemicals separated by the water/chemical separation device.

22. The system according to claim 19, wherein the second solids separation device is selected from the group of: inline strainers, rotary screens, decanter centrifuges, and clarifier centrifuges.

23. The system according to claim 20, wherein the water/chemical separation device is selected from the group of: reverse osmosis (RO) membranes, thermal vapour recompression (TVR) evaporators, mechanical vapour recompression (MVR) evaporators.

24. The system according to claim 21, wherein the a sterilization device configured to sterilize the chemicals separated by the water/chemical separation device is fluidly connected to the second cleaning agent processing apparatus.

25. The system according to claim 17, wherein the system is configured to direct the processed cleaning agent obtained from the second cleaning agent processing apparatus into the first and/or second cleaning agent tank thereby recycling the cleaning agents.

26. The system according to claim 1, wherein the plurality of recovery tanks comprise a dirty water recovery tank for recovering dirty water from the one or more return lines.

27. The system according to claim 26, wherein the system further comprises a dirty water processing apparatus fluidly connected to the dirty water recovery tank, wherein the dirty water processing apparatus is configured to process the dirty water from the dirty water recovery tank in order to separate solids from the dirty water.

28. The system according to claim 27, wherein the dirty water processing apparatus comprises:
a third solids separation device configured to separate insoluble solids from the recovered dirty water; and
a water/solids separation device configured to separate remaining solids from the recovered dirty water.

29. The system according to claim 28, wherein the third solids separation device is selected from the group of: inline strainers, rotary screens, decanter centrifuges, and clarifier centrifuges.

30. The system according to claim 28, wherein the water/solids separation device is selected from the group of: reverse osmosis (RO) membranes, thermal vapour recompression (TVR) evaporators, and mechanical vapour recompression (MVR) evaporators.

31. The system according to claim 1, wherein the system is configured for adjusting the pH value of the dirty water.

32. The system according to claim 31, wherein the system comprises an alkali container configured for adding an alkali solution to the dirty water and/or an acid container configured for adding an acidic solution to the dirty water.

33. The system according to claim 1, wherein the system comprises a pH sensor for adjusting the pH value of the dirty water.

34. The system according to claim 27, wherein the system further comprises one or more heat treatment tanks fluidly connected to the dirty water processing apparatus, said one or more heat treatment tanks configured such that the separated water and/or solids from the dirty water processing apparatus are concentrated, heat treated and optionally fermented in order to obtain an animal food, solid waste, fertilizer or bio-fuel product.

35. The system according to claim 17, wherein the system further comprises one or more clean water recovery tanks for storing water that has been separated by the second cleaning agent processing apparatus and/or dirty water processing apparatus.

36. The system according to claim 17, wherein the system further comprises a clean water processing apparatus configured to further process the clean water from the second cleaning agent processing apparatus and/or from the dirty water processing apparatus in order to obtain process water.

37. The system according to claim 36, wherein the system is configured to direct the water obtained from the second cleaning agent processing apparatus and/or dirty water processing apparatus into the clean water processing apparatus.

38. The system according to claim 36, wherein the clean water processing apparatus is configured to remove colour and/or odour from the water and/or configured to disinfect the water.

39. The system according to claim 36, wherein the clean water processing apparatus is configured to disinfect the water using any of: advanced oxidation, chlorination, quaternary ammonium, iodine disinfectants, or other disinfection chemicals, ultra-high temperature processing (UHT), and/or combinations thereof.

40. The system according to claim 36, wherein the system further comprises one or more process water tanks for storing process water, wherein the one or more process water tanks are fluidly connected to the clean water processing apparatus.

41. The system according to claim 40, wherein the system is configured to direct the water from the clean water processing apparatus into the one or more process water tank thereby recycling the water.

42. The system according to claim 1, wherein the system further comprises an emergency tank for storing liquid.

43. A clean-in-place (CIP) process wherein water and cleaning agents used in the process are recycled such that minimal or no wastewater is released to a drain in the process, said process comprising the steps of:
rinsing one or more objects fluidly connected to a CIP system by:
pushing forward process water from a process water supply of one or more process water tanks through one or more forward lines to the one or more object; or
pushing forward clean water from a clean water supply such as a clean water recovery tank through one or more forward lines to the one or more object;
returning the water from the one or more object to one or more water recovery tanks via one or more return lines from the one or more object;
monitoring by one or more sensors one or more parameters of the water in the one or more return line;
redirecting the water in the one or more return line to one or more dirty water recovery tanks in case the one or more monitored parameter exceed one or more predetermined thresholds;
processing the dirty water from the one or more dirty water recovery tank in order to obtain clean water, said process comprising the steps of:
removing insoluble solids from the dirty water;
separating water and solids, whereby clean water is obtained;
returning the clean water to one or more clean water recovery tanks thereby recycling the water used in the process;
processing the clean water from the one or more clean water recovery tank in order to obtain process water, said process comprising one, two or three of the steps of:
removing soluble and insoluble solids from the clean water;
removing colour and/or odour from the clean water;
disinfecting the clean water, whereby process water is obtained;
returning the process water to one or more process water tanks thereby recycling the water used in the process;
cleaning the one or more objects using one or more cleaning agents comprising one or more chemicals such as sodium hydroxide and/or nitric acid/phosphoric acid by pushing forward the one or more cleaning agent from one or more cleaning agent tanks via the one or more forward line to the one or more object, whereby one or more used cleaning agent are obtained;
returning the one or more used cleaning agent from the one or more object to one or more cleaning agent tanks or to one or more cleaning agent recovery tanks as one or more diluted cleaning agent via the one or more return line from the one or more object;
processing the one or more used cleaning agent from the one or more cleaning agent tank, said process comprising the steps of:
removing insoluble solids from the on or more used cleaning agents, whereby one or more processed cleaning agent are obtained;
optionally removing soluble solids from the one or more used cleaning agent;
processing the one or more diluted cleaning agent from the one or more cleaning agent recovery tank, said process comprising the step of:
separating water and chemicals from the one or more diluted cleaning agent received from the one or more cleaning agent recovery tank, whereby clean water and one or more processed cleaning agent are obtained;
returning the one or more processed cleaning agent to the one or more cleaning agent tank thereby recycling the one or more cleaning agent used in the process.

44. The process according to claim 43, wherein the parameters are selected from the group of: turbidity and/or electrical conductivity of the water.

45. The process according to claim 43, wherein the one or more cleaning agent are selected from the group of: sodium hydroxide and/or nitric acid/phosphoric acid.

46. The process according to claim 43, wherein colour and/or odour is removed from the water using an advanced oxidation process, using ozone injection into the water, using UV irradiation of the water, and/or using active coal filters with subsequent filter bags, through which the water is passing.

47. The process according to claim 43, wherein the clean water is disinfected using: an advanced oxidation process, ozone injection, UV irradiation, chemicals, e.g. chlorination, quaternary ammonium, iodine disinfectant(s), and/or ultra-high temperature processing (UHT).

48. The process according to claim 43, wherein the step of processing the one or more diluted cleaning agent from the one or more cleaning agent recovery tank comprises the step of sterilizing the chemicals using ultra-high-temperature processing.

49. The process according to claim 43, wherein the process further comprises the step of recirculating the solids solution obtained from the water processing step through the dirty water recovery tanks and one or more separation devices, whereby the concentration of the solids solution is increased.

50. The process according to claim 43, wherein the solids solution is concentrated, heat-treated and optionally fermented in order to obtain animal food, solid waste, fertilizer, or bio-fuel product.

51. The process according to claim 43, wherein the process comprises the step of determining concentration of the one or more used cleaning agent from the on or more object, and wherein the used one or more cleaning agent from the one or more object are returned to:
the one or more cleaning agent tanks if the concentration is above a certain predefined level, and/or
the one or more cleaning agent recovery tanks as the one or more diluted cleaning agent if the concentration is below the certain predefined level.

52. The process according to claim 43, wherein the step of cleaning the one or more objects using one or more cleaning agents comprises a caustic flush, wherein an alkaline solution is pushed forward from the one or more cleaning agent tanks via the one or more forward line to the one or more object.

53. The process according to claim 43, wherein the step of cleaning the one or more objects using one or more cleaning agents comprises an acid flush, wherein an acidic solution comprising nitric acid and/or phosphoric acid is pushed forward from the one or more cleaning agent tanks via the one or more forward line to the one or more object.

54. The process according to claim 42, wherein the CIP system is defined according to claim 1.

55. Use of a clean-in-place (CIP) system according to claim 1, wherein the water and cleaning agents used are processed and recycled such that minimal or no wastewater is released by the system.
